(19) United States
(12) Patent Application Publication
(10) Pub. No.: US 2007/0037086 A1
(43) Pub. Date: Feb. 15, 2007

(54) Toner composition

(75) Inventors: Vladislav Skorokhod, Mississauga (CA); Karen Ann Moffat, Brantford (CA); Wafa Faisul Bashir, Mississauga (CA); Shigang Steven Qiu, Toronto (CA); Paul Joseph Gerroir, Oakville (CA); Bruce Earl Thayer, Webster, NY (US)

Correspondence Address: Carter, DeLuca, Farrell & Schmidt, Suite 225, 445 Broadhollow Road, Melville, NY, 11738, US

(73) Assignee: Xerox Corporation

(21) Appl. No.: 11/202,135

(22) Filed: Aug. 11, 2005

(51) Int. Cl. G03G 9/08

(52) U.S. Cl. 430/110.4; 430/110.3; 430/124

(57) ABSTRACT

Toner compositions having particles with a desired circularity and size are provided.

### BACKGROUND

The present disclosure relates generally to toners and toner processes, and more specifically, to toner compositions containing small, spherical particles.

In electrophotography, an image is produced by forming an electrostatic latent image on a surface of a photoreceptor having a drum or belt shape, or the like, developing the electrostatic latent image with a toner so as to obtain a toner image, electrostatically transferring the toner image onto a recording media such as paper directly or via an intermediate transfer member, and fusing the toner onto a surface of the recording paper by heating, or the like.

In view of the recent demand for high image quality, toner with a small particle size, for example from about 1 to about 10 microns, and a narrow distribution of particle size is desirable for use in image forming devices. When the distribution of particle size is wide, the ratio of toner having a small particle size relative to toner having a large particle size, or vice versa, may be increased. This may cause certain problems, for example, in the case of a two-component developing agent including a toner and a carrier, since the toner can easily adhere to the carrier, the ability of the toner to retain a charge is deteriorated. In contrast, in the case of toner wherein there is a greater amount of large particles, there are problems such as a tendency for image quality deterioration because of inefficiency in the transfer of toner onto a recording media.

Toner of small particle size and narrow particle size distribution can be produced by emulsion aggregation methods. Methods of preparing an emulsion aggregation (EA) type toner are known and toners may be formed by aggregating a colorant with a latex polymer formed by batch or semi-continuous emulsion polymerization. For example, U.S. Pat. No. 5,853,943, the disclosure of which is hereby incorporated by reference in its entirety, is directed to a semi-continuous emulsion polymerization process for preparing a latex by first forming a seed polymer. In particular, the '943 patent describes a process comprising: (i) conducting a pre-reaction monomer emulsification which comprises emulsification of the polymerization reagents of monomers, chain transfer agent, a disulfonate surfactant or surfactants, and optionally, but preferably, an initiator, wherein the emulsification is accomplished at a low temperature of, for example, from about 5° C. to about 40° C.; (ii) preparing a seed particle latex by aqueous emulsion polymerization of a mixture comprised of (a) part of the monomer emulsion, from about 0.5 to about 50 percent by weight, or from about 3 to about 25 percent by weight, of the monomer emulsion prepared in (i), and (b) a free radical Initiator, from about 0.5 to about 100 percent by weight, or from about 3 to about 100 percent by weight, of the total initiator used to prepare the latex polymer at a temperature of from about 35° C. to about 125° C., wherein the reaction of the free radical initiator and monomer produces the seed latex comprised of latex resin wherein the particles are stabilized by surfactants; (iii) heating and feed adding to the formed seed particles the remaining monomer emulsion, from about 50 to about 99.5 percent by weight, or from about 75 to about 97 percent by weight, of the monomer emulsion prepared In (ii), and optionally a free radical initiator, from about 0 to about 99.5 percent by weight, or from about 0 to about 97 percent by weight, of the total Initiator used to prepare the latex polymer at a temperature from about 35° C. to about 125° C.; and (iv) retaining the above contents In the reactor at a temperature of from about 35° C. to about 125° C. for an effective time period to form the latex polymer, for example from about 0.5 to about 8 hours, or from about 1.5 to about 6 hours, followed by cooling. Other examples of emulsion/aggregation/coalescing processes for the preparation of toners are illustrated in U.S. Pat. Nos. 5,290,654, 5,278,020, 5,308,734, 5,370,963, 5,344,738, 5,403,693, 5,418,108, 5,364,729, and 5,346,797, the disclosures of each of which are hereby incorporated by reference in their entirety. Other processes are disclosed in U.S. Pat. Nos. 5,348,832, 5,405,728, 5,366,841, 5,496,676, 5,527,658, 5,585,215, 5,650,255, 5,650,256 and 5,501,935, the disclosures of each of which are hereby incorporated by reference in their entirety.

Toner obtained by emulsion aggregation processes has a small particle size such as from about 5 to about 7 microns, with a substantially spherical particle shape having a circularity of, for example, from about 0.93 to about 0.98, in some cases a circularity of about 0.94 to about 0.97 as measured by Malvern Sysmex Flow Particle Image Analyzer FPIA-2100.

In the developing and transferring properties of a toner, the content of fine particles generally exhibits large influence on performance and reliability. That is, as has been known, a toner having particles with a small diameter has a large adhesion force and thus is difficult to be electrostatically controlled, whereby it is liable to remain on a carrier when it is used as part of a two-component developer. When a mechanical force is repeatedly applied, it causes carrier contamination, and as a result, deterioration of the carrier is accelerated. Furthermore, since the toner having a small diameter has a large adhesion force, it causes deterioration in developing efficiency, and as a result, image defects are formed. In the transferring step, it is difficult to transfer a small diameter component of the toner developed on a photoreceptor thus impairing the transfer efficiency, and thereby increasing toner waste and deterioration in image quality.

Many image forming devices have cleaning devices, for example, cleaning blades, to remove residual toner from the system, including the image holding member. Unfortunately, for toner sizes below about 6 microns, from about 0.1 microns to about 6 microns, it becomes difficult to remove residual toner with a cleaning device such as a cleaning blade. For example, since a small-particle spherical toner cannot be cleaned completely with a blade, the toner passes under the blade. The toner thus passes between the contacting portions of the image holding member and the contact charger and is deformed by the contact charger and adheres to the surface of the image holding member. Due to repetition of the adhesion of toner, the toner becomes fixed on the surface of the image holding member, which can have an adverse effect on image quality, for example, darker images and streaking on prints. Therefore, with the development of images, if the size of the particles is too large or too small, image quality can become poor due to inefficient cleaning and/or transfer.

Hence, toner shape and size affect the performance attributes of image forming devices such as developability, transfer, and cleaning. Blade cleaning may be enhanced where larger and less spherical particles are utilized, while transfer components may work better with more spherical particles to minimize particle-to-photoreceptor adhesion force by minimizing the contact area. Hence, it would be advantageous to provide a toner composition with particles of small size made by the emulsion aggregation method that provides a balance between development, transfer, and cleaning.

### SUMMARY

The present disclosure provides a toner composition that includes particles having a size of from about 2 microns to about 4 microns present in an amount of from about 12 percent to about 25 percent by weight of the toner composition.

The present disclosure also provides a xerographic system including a charging component, an imaging component, a development component, a transfer component and a fixing component. The development component includes a toner composition having particles with a size of from about 2 microns to about 4 microns present in an amount of from about 12 percent to about 25 percent by weight of the toner composition.

In embodiments, the present disclosure describes a xerographic process that includes depositing a toner composition on a latent electrostatic image, the toner composition having particles with a size of from about 2 microns to about 4 microns present in an amount of from about 12 percent to about 25 percent by weight of the toner composition; transferring the image to a support surface; and affixing the image to the support surface.

Also described are developer compositions that include carrier particles and toner with particles having a size of from about 2 microns to about 4 microns present in an amount of from about 12 percent to about 25 percent by weight of the toner composition.

### BRIEF DESCRIPTION OF THE DRAWINGS

Various embodiments of the present disclosure will be described herein below with reference to the figures wherein:

FIG. 1 is a table depicting components of toner particles of the present disclosure and the final particle properties of such toners;

FIG. 2 is a graphical correlation showing development voltage and toner fines contents of toner of the present disclosure in three different size ranges; and

FIG. 3 is a table depicting components of toner particles of the present disclosure and the final particle properties of such toners.

### DETAILED DESCRIPTION

In accordance with the present disclosure, toner compositions are provided including toner particles having a narrow range of particle size and particle circularity.

The toner compositions generated in embodiments of the present disclosure include, for example, particles with a volume average diameter of from about 2 microns to about 4 microns, and in embodiments of from about 2.25 microns to about 3.75 microns, in an amount of from about 12% to about 25%, and in embodiments of from about 14% to about 18% by weight of the total toner composition.

The toner of the present disclosure may have particles with a circularity of from about 0.93 to about 0.98, and in embodiments of from about 0.94 to about 0.97. When the spherical toner particles have a circularity in this range, the spherical toner particles remaining on the surface of the image holding member pass between the contacting portions of the imaging holding member and the contact charger, the amount of deformed toner is small, and therefore generation of toner filming can be prevented so that a stable image quality without defects can be obtained over a long period. The toner composition of the present disclosure is particularly useful in electrostatic imaging processes wherein blade cleaning is utilized for the removal of unwanted toner particles from the photoreceptor surface. The circularity of the toner of the present disclosure enables the toner to be cleaned when the toner passes under a cleaning blade with a minimum blade load to clean of from about 11 grams per centimeter (g/cm) to about 39 g/cm, and in embodiments of from about 12 g/cm to about 30 g/cm.

The particles of the present disclosure possess both transfer and development efficiency and are able to produce images of consistent quality without the formation of dark spots and/or streaking. When used in an imaging process, the toner composition of the present disclosure has a solid area image density of from about 12 to about 30 L* units at development voltages of from about 100V to about 400 V, and in embodiments from about 19 to about 22 L* units at development voltages of from about 150V to about 390V. (L* units represents the differential response of the human eye to a developed image and is used as a metric for density variation.) The toner composition further has a transfer efficiency of from about 75% to about 100%, and in embodiments from about 95% to about 100%.

In embodiments, the toners are an emulsion aggregation type toner that are prepared by the aggregation and fusion of latex resin particles with a colorant, and one or more additives such as surfactants, coagulants, waxes, surface additives, and optionally mixtures thereof. In embodiments, one or more is from about one to about twenty and in embodiments, from about three to about ten.

In embodiments, a latex which may be utilized includes, for example, submicron non-crosslinked resin particles in the size range of, for example, from about 50 to about 500 nanometers and in embodiments, from about 100 to about 400 nanometers in volume average diameter as determined, for example, by a Brookhaven nanosize particle analyzer. The non-crosslinked resin is generally present in the toner composition of from about 75 weight percent to about 98 weight percent, and in embodiments from about 80 weight percent to about 95 weight percent of the toner or the solids of the toner. The expression solids can refer, in embodiments, to the latex, colorant, wax, and any other optional additives of the toner composition.

In embodiments of the present disclosure, the non-crosslinked resin in the latex is derived from the emulsion polymerization of monomers including, but not limited to, styrenes, butadienes, isoprenes, acrylates, methacrylates, acrylonitriles, acrylic acid, methacrylic acid, itaconic or beta carboxy ethyl acrylate (β-CEA) and the like.

In embodiments, the non-crosslinked resin of the latex may include at least one polymer. In embodiments, at least one is from about one to about twenty and in embodiments, from about three to about ten. Exemplary polymers includes styrene acrylates, styrene butadienes, styrene methacrylates, and more specifically, poly(styrene-alkyl acrylate), poly(styrene-1,3-diene), poly(styrene-alkyl methacrylate), poly (styrene-alkyl acrylate-acrylic acid), poly(styrene-1,3-diene-acrylic acid), poly (styrene-alkyl methacrylate-acrylic acid), poly(alkyl methacrylate-alkyl acrylate), poly(alkyl methacrylate-aryl acrylate), poly(aryl methacrylate-alkyl acrylate), poly(alkyl methacrylate-acrylic acid), poly(styrene-alkyl acrylate-acrylonitrile-acrylic acid), poly (styrene-1,3-diene-acrylonitrile-acrylic acid), poly(alkyl acrylate-acrylonitrile-acrylic acid), poly(styrene-butadiene), poly(methylstyrene-butadiene), poly(methyl methacrylate-butadiene), poly(ethyl methacrylate-butadiene), poly(propyl methacrylate-butadiene), poly(butyl methacrylate-butadiene), poly(methyl acrylate-butadiene), poly(ethyl acrylate-butadiene), poly(propyl acrylate-butadiene), poly(butyl acrylate-butadiene), poly(styrene-isoprene), poly(methylstyrene-isoprene), poly (methyl methacrylate-isoprene), poly(ethyl methacrylate-isoprene), poly(propyl methacrylate-isoprene), poly(butyl methacrylate-isoprene), poly(methyl acrylate-isoprene), poly(ethyl acrylate-isoprene), poly(propyl acrylate-isoprene), poly(butyl acrylate-isoprene), poly(styrene-propyl acrylate), poly(styrene-butyl acrylate), poly (styrene-butadiene-acrylic acid), poly(styrene-butadiene-methacrylic acid), poly (styrene-butadiene-acrylonitrile-acrylic acid), poly(styrene-butyl acrylate-acrylic acid), poly(styrene-butyl acrylate-methacrylic acid), poly(styrene-butyl acrylate-acrylononitrile), poly(styrene-butyl acrylate-acrylonitrile-acrylic acid), poly(styrene-butadiene), poly(styrene-isoprene), poly(styrene-butyl methacrylate), poly(styrene-butyl acrylate-acrylic acid), poly(styrene-butyl methacrylate-acrylic acid), poly(butyl methacrylate-butyl acrylate), poly(butyl methacrylate-acrylic acid), poly(acrylonitrile-butyl acrylate-acrylic acid), and mixtures thereof. In embodiments, the polymer is poly(styrene/butyl acrylate/beta carboxyl ethyl acrylate). The polymer may be block, random, or alternating copolymers.

In embodiments, the latex may be prepared by a batch or a semicontinuous polymerization resulting in submicron non-crosslinked resin particles suspended in an aqueous phase containing a surfactant. Surfactants which may be utilized in the latex dispersion can be ionic or nonionic surfactants in an amount of from about 0.01 to about 15, and in embodiments of from about 0.01 to about 5 weight percent of the solids.

Anionic surfactants which may be utilized include sulfates and sulfonates such as sodium dodecylsulfate (SDS), sodium dodecyl benzene sulfonate, sodium dodecylnaphthalene sulfate, dialkyl benzenealkyl sulfates and sulfonates, abitic acid, and the NEOGEN brand of anionic surfactants. In embodiments a suitable anionic surfactant is NEOGEN RK available from Daiichi Kogyo Seiyaku Co. Ltd., or TAYCA POWER BN2060 from Tayca Corporation (Japan), which are branched sodium dodecyl benzene sulfonates.

Examples of cationic surfactants include ammoniums such as dialkyl benzene alkyl ammonium chloride, lauryl trimethyl ammonium chloride, alkylbenzyl methyl ammonium chloride, alkyl benzyl dimethyl ammonium bromide, benzalkonium chloride, C₁₂, C₁₅, C₁₇ trimethyl ammonium bromides, mixtures thereof, and the like. Other cationic surfactants include cetyl pyridinium bromide, halide salts of quaternized polyoxyethylalkylamines, dodecyl benzyl triethyl ammonium chloride, MIRAPOL and ALKAQUAT available from Alkaril Chemical Company, SANISOL (benzalkonium chloride), available from Kao Chemicals, and the like. In embodiments a suitable cationic surfactant includes SANISOL B-50 available from Kao Corp., which is primarily a benzyl dimethyl alkonium chloride.

Exemplary nonionic surfactants include alcohols, acids, celluloses and ethers, for example, polyvinyl alcohol, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy) ethanol available from Rhone-Poulenc as IGEPAL CA-210™, IGEPAL CA-520™, IGEPAL CA-720TM, IGEPAL CO-890™, IGEPAL CO-720TM, IGEPAL CO-290™, IGEPAL CA-21OTM, ANTAROX 890™ and ANTAROX 897™. In embodiments a suitable nonionic surfactant is ANTAROX 897 available from Rhone-Poulenc Inc., which is primarily an alkyl phenol ethoxylate.

In embodiments, the non-crosslinked resin may be prepared with initiators, such as water soluble initiators and organic soluble initiators. Exemplary water soluble initiators are ammonium and potassium persulfates and can be added in suitable amounts, such as from about 0.1 to about 8 weight percent, and in embodiments of from about 0.2 to about 5 weight percent of the monomer. Examples of organic soluble initiators include Vazo peroxides, such as Vazo 64, 2-methyl 2-2′-azobis propanenitrile, and Vazo 88, 2-2′-azobis isobutyramide dehydrate in a suitable amount, such as from about 0.1 to about 8 percent, and in embodiments of from about 0.2 to about 5 weight percent of the monomer.

Known chain transfer agents can also be utilized to control the molecular weight properties of the resin if prepared by emulsion polymerization. Examples of chain transfer agents include dodecane thiol, dodecylmercaptan, octane thiol, carbon tetrabromide, carbon tetrachloride and the like in various suitable amounts, such as from about 0.1 to about 20 percent, and in embodiments of from about 0.2 to about 10 percent by weight of the monomer.

Other processes for obtaining resin particles can be produced by a polymer microsuspension process as disclosed in U.S. Pat. No. 3,674,736, the disclosure of which is hereby incorporated by reference in its entirety, polymer solution microsuspension process as disclosed in U.S. Pat. No. 5,290,654, the disclosure of which is hereby incorporated by reference in its entirety, and mechanical grinding processes, or other known processes.

In embodiments, a gel latex may be added to the non-crosslinked latex resin suspended in the surfactant. A gel latex may refer, in embodiments, for example to a crosslinked resin or polymer, or mixtures thereof, or a crosslinked resin of a non-crosslinked resin with crosslinking.

The gel latex may include, for example, submicron crosslinked resin particles in the size range of, for example, from about 10 to about 200 nanometers, and in embodiments of from about 20 to 100 nanometers in volume average diameter. The gel latex may be suspended in an aqueous phase of water containing a surfactant, wherein the surfactant is selected in an amount from about 0.5 to about 5 percent by weight of the solids, and in embodiments from about 0.7 to about 2 percent by weight of the solids.

The crosslinked resin may be a crosslinked polymer such as crosslinked styrene acrylates, styrene butadienes, and/or styrene methacrylates. In particular, exemplary crosslinked resins are crosslinked poly(styrene-alkyl acrylate), poly(styrene-butadiene), poly(styrene-isoprene), poly(styrene-alkyl methacrylate), poly(styrene-alkyl acrylate-acrylic acid), poly(styrene-butadiene-acrylic acid), poly(styrene-isoprene-acrylic acid), poly (styrenealkyl methacrylate-acrylic acid), poly(alkyl methacrylate-alkyl acrylate), poly (alkyl methacrylate-aryl acrylate), poly(aryl methacrylate-alkyl acrylate), poly(alkyl methacrylate-acrylic acid), poly(styrene-alkyl acrylate-acrylonitrile acrylic acid), crosslinked poly(alkyl acrylate-acrylonitrile-acrylic acid), and mixtures thereof.

A crosslinker, such as divinyl benzene or other divinyl aromatic or divinyl acrylate or methacrylate monomers may be used in the crosslinked resin. The crosslinker may be present in an amount of from about 0.01 percent by weight to about 25 percent by weight, and in embodiments of from about 0.5 to about 15 percent by weight of the crosslinked resin.

The crosslinked resin particles may be present in an amount of from about 0.1 to about 50 weight percent, and in embodiments of from about 1 to about 20 percent by weight of the toner.

In embodiments of the present disclosure, the gel latex may be a mixture of a crosslinked resin and a non-crosslinked resin.

The latex and gel latex may be added to a colorant dispersion and a wax dispersion. The colorant dispersion includes, for example, submicron colorant particles in the size range of, for example, from about 50 to about 500 nanometers and in embodiments, of from about 100 to about 400 nanometers in volume average diameter. The colorant particles may be suspended in an aqueous water phase containing an anionic surfactant, a nonionic surfactant, or mixtures thereof. In embodiments, the surfactant may be ionic and is from about 1 to about 25 percent by weight, and in embodiments from about 4 to about 15 percent by weight of the colorant.

Colorants include pigments, dyes, mixtures of pigments and dyes, mixtures of pigments, mixtures of dyes, and the like. The colorant may be, for example, carbon black, cyan, yellow, magenta, red, orange, brown, green, blue, violet or mixtures thereof.

In embodiments wherein the colorant is a pigment, the pigment may be, for example, carbon black, phthalocyanines, quinacridones or RHODAMINE B™ type, red, green, orange, brown, violet, yellow, fluorescent colorants and the like.

The colorant may be present in the toner of the disclosure in an amount of from about 1 to about 25 percent by weight of toner, in embodiments in an amount of from about 2 to about 15 percent by weight of the toner.

Exemplary colorants include carbon black like REGAL 330® magnetites; Mobay magnetites including MO8029™, MO8060™; Columbian magnetites; MAPICO BLACKS™ and surface treated magnetites; Pfizer magnetites including CB4799™, CB5300™, CB560O™, MCX6369™; Bayer magnetites including, BAYFERROX 8600™, 8610™; Northern Pigments magnetites including, NP-604™, NP-608™; Magnox magnetites including TMB-100™, or TMB-104™, HELIOGEN BLUE L6900™, D6840™, D7080™, D7020™, PYLAM OIL BLUE™, PYLAM OIL YELLOW™, PIGMENT BLUE 1 ™available from Paul Uhlich and Company, Inc.; PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario; NOVAPERM YELLOW FGL™, HOSTAPERM PINK E™ from Hoechst; and CINQUASIA MAGENTA™ available from E.l. DuPont de Nemours and Company. Other colorants include 2,9-dimethyl-substituted quinacridone and anthraquinone dye identified in the Color Index as Cl 60710, Cl Dispersed Red 15, diazo dye identified in the Color Index as Cl 26050, Cl Solvent Red 19, copper tetra(octadecyl sulfonamido) phthalocyanine, x-copper phthalocyanine pigment listed in the Color Index as Cl 74160, Cl Pigment Blue, Anthrathrene Blue identified in the Color Index as Cl 69810, Special Blue X-2137, diarylide yellow 3,3-dichlorobenzidene acetoacetanilides, a monoazo pigment identified in the Color Index as Cl 12700, Cl Solvent Yellow 16, a nitrophenyl amine sulfonamide identified in the Color Index as Foron Yellow SE/GLN, Cl Dispersed Yellow 33, 2,5-dimethoxy-4-sulfonanilide phenylazo-4′-chloro-2,5-dimethoxy acetoacetanilide, Yellow 180 and Permanent Yellow FGL. Organic soluble dyes having a high purity for the purpose of color gamut which may be utilized include Neopen Yellow 075, Neopen Yellow 159, Neopen Orange 252, Neopen Red 336, Neopen Red 335, Neopen Red 366, Neopen Blue 808, Neopen Black X53, Neopen Black X55, wherein the dyes are selected in various suitable amounts, for example from about 0.5 to about 20 percent by weight, in embodiments, from about 5 to about 20 weight percent of the toner.

Wax dispersions suitable for use in toners of the present disclosure include, for example, submicron wax particles in the size range of from about 50 to about 500 nanometers, in embodiments of from about 100 to about 400 nanometers in volume average diameter, suspended in an aqueous phase of water and an ionic surfactant, nonionic surfactant, or mixtures thereof. The ionic surfactant or nonionic surfactant may be present in an amount of from about 0.5 to about 10 percent by weight, and in embodiments of from about 1 to about 5 percent by weight of the wax.

The wax dispersion according to embodiments of the present disclosure includes a wax for example, a natural vegetable wax, natural animal wax, mineral wax and/or synthetic wax. Examples of natural vegetable waxes include, for example, carnauba wax, candelilla wax, Japan wax, and bayberry wax. Examples of natural animal waxes include, for example, beeswax, punic wax, lanolin, lac wax, shellac wax, and spermaceti wax. Mineral waxes include, for example, paraffin wax, microcrystalline wax, montan wax, ozokerite wax, ceresin wax, petrolatum wax, and petroleum wax. Synthetic waxes of the present disclosure include, for example, Fischer-Tropsch wax, acrylate wax, fatty acid amide wax, silicone wax, polytetrafluoroethylene wax, polyethylene wax, polypropylene wax, and mixtures thereof.

Examples of polypropylene and polyethylene waxes include those commercially available from Allied Chemical and Baker Petrolite, wax emulsions available from Michelman Inc. and the Daniels Products Company, EPOLENE N-15 commercially available from Eastman Chemical Products, Inc., Viscol 550-P, a low weight average molecular weight polypropylene available from Sanyo Kasel K.K., and similar materials. In embodiments, commercially available polyethylene waxes possess a molecular weight (Mw) of from about 1,000 to about 1,500, and in embodiments of from about 1,250 to about 1,400, while the commercially available polypropylene waxes have a molecular weight of from about 4,000 to about 5,000, and in embodiments of from about 4,250 to about 4,750.

In embodiments, the waxes may be functionalized. Examples of groups added to functionalize waxes include amines, amides, imides, esters, quaternary amines, and/or carboxylic acids. In embodiments, the functionalized waxes may be acrylic polymer emulsions, for example, Joncryl 74, 89, 130, 537, and 538, all available from Johnson Diversey, Inc, or chlorinated polypropylenes and polyethylenes commercially available from Allied Chemical and Petrolite Corporation and Johnson Diversey, Inc.

The wax may be present in an amount of from about 1 to about 30 percent by weight, and in embodiments from about 2 to about 20 percent by weight of the toner.

The resultant blend of latex dispersion, gel latex dispersion, colorant dispersion, and wax dispersion may be stirred and heated to a temperature of from about 45° C. to about 65° C., in embodiments of from about 48° C. to about 63° C., resulting in toner aggregates of from about 5 microns to about 8 microns in volume average diameter, and in embodiments of from about 5 microns to about 6.5 microns in volume average diameter.

In embodiments, a coagulant may be added during or prior to aggregating the latex, the aqueous colorant dispersion, the wax dispersion and the gel latex. The coagulant may be added over a period of time from about 1 to about 5 minutes, in embodiments from about 1.25 to about 3 minutes.

Examples of coagulants include polyaluminum halides such as polyaluminum chloride (PAC), or the corresponding bromide, fluoride, or iodide, polyaluminum silicates such as polyaluminum sulfo silicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate and the like. One suitable coagulant is PAC, which is commercially available and can be prepared by the controlled hydrolysis of aluminum chloride with sodium hydroxide. Generally, PAC can be prepared by the addition of two moles of a base to one mole of aluminum chloride. The species is soluble and stable when dissolved and stored under acidic conditions if the pH is less than about 5. The species in solution is believed to be of the formula A1₁₃0₄(OH)₂₄(H₂0)₁₂ with about 7 positive electrical charges per unit.

In embodiments, suitable coagulants include a polymetal salt such as, for example, polyaluminum chloride (PAC), polyaluminum bromide, or polyaluminum sulfosilicate. The polymetal salt can be in a solution of nitric acid, or other diluted acid solutions such as sulfuric acid, hydrochloric acid, citric acid or acetic acid. The coagulant may be added in amounts from about 0.02 to about 0.3 percent by weight of the toner, and in embodiments from about 0.05 to about 0.2 percent by weight of the toner.

Optionally a second latex can be added to the aggregated particles. The second latex may include, for example, submicron non-crosslinked resin particles. The second latex may be added in an amount of from about 10 to about 40 percent by weight of the initial latex, and in embodiments in an amount of from about 15 to about 30 percent by weight of the initial latex, to form a shell or coating on the toner aggregates wherein the thickness of the shell is from about 200 to about 800 nanometers, and in embodiments from about 250 to about 750 nanometers.

In embodiments of the present disclosure, the latex and the second latex comprise the same non-crosslinked resin.

In embodiments, the latex and the second latex comprise different non- crosslinked resins.

Once the desired final size of the particles is achieved with a volume average diameter of from about 5 microns to about 7 microns, and in embodiments of from about 5.3 microns to about 6.5 microns, the pH of the mixture may be adjusted with a base to a value of from about 5 to about 7, and in embodiments from about 6 to about 6.8. The base may include any suitable base such as, for example, alkali metal hydroxides such as, for example, sodium hydroxide, potassium hydroxide, and ammonium hydroxide. The alkali metal hydroxide may be added in amounts from about 6 to about 25 percent by weight of the mixture, in embodiments from about 10 to about 20 percent by weight of the mixture.

The mixture is subsequently coalesced. Coalescing may include stirring and heating at a temperature of from about 90° C. to about 99° C., for a period of from about 0.5 to about 6 hours, and in embodiments from about 2 to about 5 hours. Coalescing may be accelerated by additional stirring.

The pH of the mixture is then lowered to from about 3.5 to about 6 and in embodiments, to from about 3.7 to about 5.5 with, for example, an acid to coalesce the toner aggregates. Suitable acids include, for example, nitric acid, sulfuric acid, hydrochloric acid, citric acid or acetic acid. The amount of acid added may be from about 4 to about 30 percent by weight of the mixture, and in embodiments from about 5 to about 15 percent by weight of the mixture.

The mixture is cooled, washed and dried. Cooling may be at a temperature of from about 20° C. to about 40° C., in embodiments from about 22° C. to about 30° C. over a period time from about 1 hour to about 8 hours, and in embodiments from about 1.5 hours to about 5 hours.

In embodiments, cooling a coalesced toner slurry includes quenching by adding a cooling media such as, for example, ice, dry ice and the like, to effect rapid cooling to a temperature of from about 20° C. to about 40° C., and in embodiments of from about 22° C. to about 30° C. Quenching may be feasible for small quantities of toner, such as, for example, less than about 2 liters, in embodiments from about 0.1 liters to about 1.5 liters. For larger scale processes, such as for example greater than about 10 liters in size, rapid cooling of the toner mixture is not feasible nor practical, neither by the introduction of a cooling medium into the toner mixture, nor by the use of jacketed reactor cooling.

The washing may be carried out at a pH of from about 7 to about 12, and in embodiments at a pH of from about 9 to about 11. The washing is at a temperature of from about 45° C. to about 70° C., and in embodiments from about 50° C. to about 67° C. The washing may include filtering and reslurrying a filter cake including toner particles in deionized water. The filter cake may be washed one or more times by deionized water, or washed by a single deionized water wash at a pH of about 4 wherein the pH of the slurry is adjusted with an acid, and followed optionally by one or more deionized water washes.

Drying is typically carried out at a temperature of from about 35° C. to about 75° C., and in embodiments of from about 45° C. to about 60° C. The drying may be continued until the moisture level of the particles is below a set target of about 1% by weight, in embodiments of less than about 0.7% by weight.

The toner may also include any known charge additives in amounts of from about 0.1 to about 10 weight percent, and in embodiments of from about 0.5 to about 7 weight percent of the toner. Examples of such charge additives include alkyl pyridinium halides, bisulfates, the charge control additives of U.S. Pat. Nos. 3,944,493, 4,007,293, 4,079,014, 4,394,430 and 4,560,635, the disclosures of each of which are hereby incorporated by reference in their entirety, negative charge enhancing additives like aluminum complexes, and the like.

Surface additives can be added to the toner compositions of the present disclosure after washing or drying. Examples of such surface additives include, for example, metal salts, metal salts of fatty acids, colloidal silicas, metal oxides, strontium titanates, mixtures thereof, and the like. Surface additives may be present in an amount of from about 0.1 to about 10 weight percent, and in embodiments of from about 0.5 to about 7 weight percent of the toner. Example of such additives include those disclosed in U.S. Pat. Nos. 3,590,000, 3,720,617, 3,655,374 and 3,983,045, the disclosures of each of which are hereby incorporated by reference in their entirety. Other additives include zinc stearate and AEROSIL R972® available from Degussa. The coated silicas of U.S. Pat. Nos. 6,190,815 and 6,004,714, the disclosures of each of which are hereby incorporated by reference in their entirety, can also be present in an amount of from about 0.05 to about 5 percent, and in embodiments of from about 0.1 to about 2 percent of the toner, which additives can be added during the aggregation or blended into the formed toner product.

Toner in accordance with the present disclosure can be used in a variety of imaging devices including printers, copy machines, and the like. The toners generated in accordance with the present disclosure are excellent for imaging processes, especially xerographic processes, which may operate with a toner transfer efficiency in excess of about 90 percent, such as those with a compact machine design without a cleaner or those that are designed to provide high quality colored images with excellent image resolution, acceptable signal-to-noise ratio, and image uniformity. Further, toners of the present disclosure can be selected for electrophotographic imaging and printing processes such as digital imaging systems and processes.

The imaging process includes the generation of an image in an electronic printing apparatus and thereafter developing the image with a toner composition of the present disclosure. The formation and development of images on the surface of photoconductive materials by electrostatic means is well known. The basic xerographic process involves placing a uniform electrostatic charge on a photoconductive insulating layer, exposing the layer to a light and shadow image to dissipate the charge on the areas of the layer exposed to the light and developing the resulting latent electrostatic image by depositing on the image a finely-divided electroscopic material referred to in the art as “toner”. The toner will normally be attracted to the discharged areas of the layer, thereby forming a toner image corresponding to the latent electrostatic image. This powder image may then be transferred to a support surface such as paper. The transferred image may subsequently be permanently affixed to the support surface as by heat.

Developer compositions can be prepared by mixing the toners obtained with the embodiments of the present disclosure with known carrier particles, including coated carriers, such as steel, ferrites, and the like. See, for example, U.S. Pat. Nos. 4,937,166 and 4,935,326, the disclosures of each of which are hereby incorporated by reference in their entirety. The toner-to-carrier mass ratio of such developers may be from about 2 to about 20 percent, and in embodiments from about 2.5 to about 5 percent of the developer composition. The carrier particles can include a core with a polymer coating thereover, such as polymethylmethacrylate (PMMA), having dispersed therein a conductive component like conductive carbon black. Carrier coatings include silicone resins, fluoropolymers, mixtures of resins not in close proximity in the triboelectric series, thermosetting resins, and other known components.

Development may occur via discharge area development. In discharge area development, the photoreceptor is charged and then the areas to be developed are discharged. The development fields and toner charges are such that toner is repelled by the charged areas on the photoreceptor and attracted to the discharged areas. This development process is used in laser scanners.

Development may be accomplished by the magnetic brush development process disclosed in U.S. Pat. No. 2,874,063, the disclosure of which is hereby incorporated by reference in its entirety. This method entails the carrying of a developer material containing toner of the present disclosure and magnetic carrier particles by a magnet. The magnetic field of the magnet causes alignment of the magnetic carriers in a brush like configuration, and this “magnetic brush” is brought into contact with the electrostatic image bearing surface of the photoreceptor. The toner particles are drawn from the brush to the electrostatic image by electrostatic attraction to the discharged areas of the photoreceptor, and development of the image results. In embodiments, the conductive magnetic brush process is used wherein the developer comprises conductive carrier particles and is capable of conducting an electric current between the biased magnet through the carrier particles to the photoreceptor.

The following Examples are being submitted to illustrate embodiments of the present disclosure. These Examples are intended to be illustrative only and are not intended to limit the scope of the present disclosure. Also, parts and percentages are by weight unless otherwise indicated.

### EXAMPLES

### Example 1

A styrene/butyl acrylate polymer latex (Latex 1) was prepared by semi- continuous emulsion polymerization at about 81.7/18.3 composition ratio (by weight). The polymer also contained about 0.35 parts per hundred (pph) of cross linking agent (decanedioldiacrylate) and was acid functionalized by the inclusion of about 3 pph beta-carboxyethylacrylate. Molecular weight was controlled by the addition of dodecanethiol to the monomer mixture; about 0.7 pph was added in the first half of the monomer feed and the remaining about 2.38 pph was added in the second half of the monomer feed. The monomer was fed into the reactor as an oil-in-water emulsion prepared with Dowfax anionic surfactant. The reaction was conducted at about 75° C. and the monomer was fed in over about 200 minutes. The initiator, ammonium persulfate, was used at a concentration of about 1.5 pph. The final properties of the latex (Latex 1) determined by Gel Permeation Chromatography/Size Exclusion Chromatography were Mw about 37,600, Mn about 11,200, Tg (onset) about 59.6° C., particle size about 211 nm, and about 41.6% solids.

A second styrene/butyl acrylate polymer latex (gel latex) was prepared by semi-continuous emulsion polymerization at about 65/35 composition ratio (by weight). The polymer also contained about 1 pph of cross linking agent (divinyl benzene) and was acid functionalized by the inclusion of about 3 pph beta-carboxyethylacrylate. The monomer was fed into the reactor as an oil-in-water emulsion prepared with Neogen RK anionic surfactant. The reaction was conducted at about 75° C. and the monomer was fed in over about 100 minutes. The initiator, ammonium persulfate, was used at a concentration of about 1.7 pph. The final properties of the latex (Latex 2), determined as described above for Latex 1, were Tg (onset) about 42° C., particle size about 46 nm, and about 25.7% solids. Due to the extensive gelation of this latex, molecular weight properties could not be reliably determined.

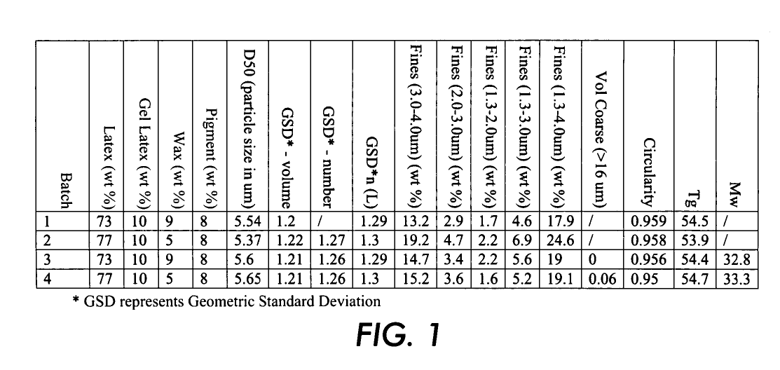

To form the toner particles, the prepared latexes were mixed with a carbon black pigment dispersion and a wax dispersion and flocculated with polyaluminum chloride. The slurry was homogenized and then heated with mixing to control particle growth. Once the appropriate size of flocculated particles had been achieved (about 5 or about 6 microns depending on the desired final size as measured on a Beckman Coulter multisizer), a second lot of the latex was added to form a shell layer. Once the desired final size was achieved (about 5.7 um or about 6.7 um), the particle growth was stopped by the addition of base to adjust the pH from about 5 to about 7. The slurry was then heated to about 96° C. and the particles were allowed to coalesce at a pH from about 3.5 to about 6 until the desired particle shape was achieved (circularity of about 0.95 to about 0.96 as determined by Malvern's Sysmex FPIA-2100 Flow Particle Image Analyzer). The formulation of the toner particles and the final particle properties are listed in FIG. 1. Note that GSD represents geometric standard deviation, D50 represents the median particle size, and GSDn (L) represents the geometric standard deviation by number based on the lower end of the distribution.

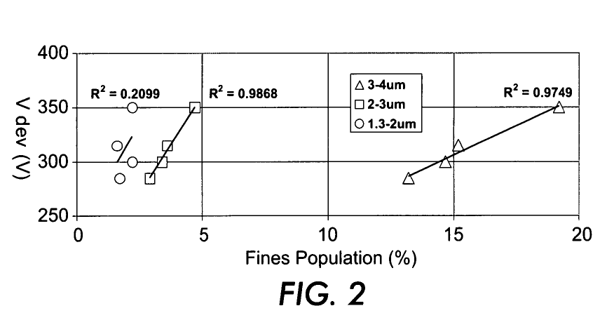

Developers were prepared by blending the toner particles with the surface additive package described in co-pending patent application, Xerox Docket No. A3217-US-CIP by McDougall, the disclosure of which is hereby incorporated by reference in its entirety. Blended toners were mixed at about 4 pph with carrier comprising magnetite core with mean particle size of about 55 to about 75 microns and a coating comprised of poly-methyl-methacrylate and carbon black mixture. The resulting developers were loaded in a Xerox DC555 developer housing. Developed toner per unit area was measured from about a 1 cm×5 cm solid area patch to determine solid area image density. Nominal development voltage (V dev) was determined as the potential difference between the magnetic roller and potential of the exposed (that is, discharged) area of the photoreceptor that resulted in a developed mass per unit area (DMA) of about 0.5 mg/cm². Triboelectric charge to mass ratio of the toner (q/m) was maintained at a constant level of about 35 uC/g (micro Coulombs per gram). The results are summarized in Table 1. Note that developer 5, 6, 7, and 8 were prepared from toner batch 1, 3, 2, and 4, respectively. The correlation plots between V dev and fines content as seen in FIG. 2. indicate significant correlation between V dev and fines content in the ranges of about 2 to about 3 microns and about 3 to about 4 microns: V dev increased with increase in fines amount indicating that the presence of fines created an obstacle to development. There was no significant correlation between V dev and toner fines with sizes of less than about 2 microns. Note that the most desirable range of V dev for the systems of the present disclosure was from about 200 V to about 350 V.

TABLE 1

| | | | | | | | V dev |
|---|---|---|---|---|---|---|---|
| De- | Cir- | | Fines | Fines | Fines | Fines | (q/m = |
| vel- | cular- | | 3-4 um | 2-3 um | 1.3-2 um | 1.3-3 um | 35 |
| oper | ity | D50 | (wt %) | (wt %) | (wt %) | (wt %) | uC/g) |
| 5 | 0.959 | 5.54 | 13.2 | 2.9 | 1.7 | 4.6 | 285 |
| 6 | 0.956 | 5.60 | 14.7 | 3.4 | 2.2 | 5.6 | 300 |
| 7 | 0.958 | 5.37 | 19.2 | 4.7 | 2.2 | 6.9 | 350 |
| 8 | 0.950 | 5.65 | 15.2 | 3.6 | 1.6 | 5.2 | 315 |

### Example 2

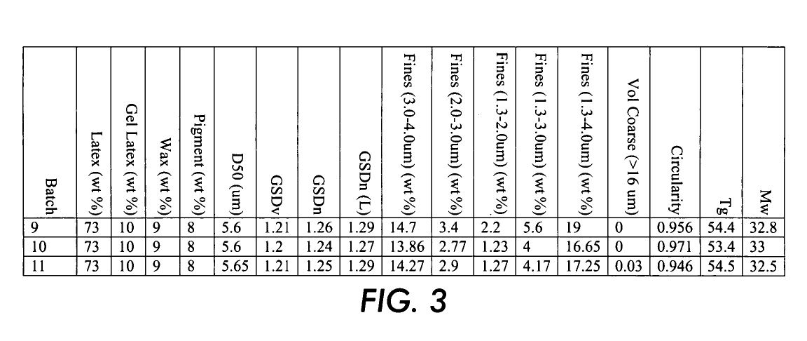

Additional Emulsion aggregation toner particles and developers were prepared using the process described in Example 1, with variations in the pH and/or the length of time for coalescence. The particles batches 9 to 11 were prepared using the same formulation as described in Example 1. The difference in particle circularity was achieved by modifying the pH, coalescence temperature and time. For particle batch 9 and 10 the pH was adjusted to a range from 4.0 to 5.0 at the start of coalescence at 96° C. for a targeted coalescence time of 5 hours. During the coalescence stage the circularity was monitored and pH was raised to neutral value once the desired circularity was reached. For particle batch 11 with the lowest circularity the coalescence temperature was reduced to 89° C. for 5 hours starting at pH ranging from 4.0 to 5.0. The properties of the toner particles can be found in FIG. 3.

The developers were loaded into a Xerox DC 575 printer. Minimum blade load for good cleaning was measured at time 0 (as prepared) developer, and for developers aged for about 30 minutes and about 60 minutes without throughput. The results are summarized in Table 2 below. The control sample was about a 9 micron polyester toner containing carbon black and wax with silica and titanium dioxide surface additives.

TABLE 2

| Developer Age | Control sample | Batch 11 | Batch 9 | Batch 10 |
|---|---|---|---|---|
| (minutes) | (g/cm) | (g/cm) | (g/cm) | (g/cm) |
| 0 | 11.8 | 11.8 | 13.2 | 25.4 |
| 30 | 12 | 11.4 | 19 | 27 |
| 60 | 11.8 | 11.4 | 30.3 | 28.1 |

The nominal blade load range for the present system was from about 26.7 to about 45.5 g/cm. As seen in Table 2, the toner of the present disclosure maintained a clean blade load.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. A toner composition comprising particles having a size of from about 2 microns to about 4 microns present in an amount of from about 12 percent to about 25 percent by weight of the toner composition.

2. The toner composition according to claim 1, wherein the particles have a circularity of from about 0.93 to about 0.98.

3. The toner composition according to claim 1, wherein the particles have a size of from about 2.25 microns to about 3.75 microns present in an amount of from about 14 percent to about 18 percent by weight of the total toner composition and a circularity of from about 0.94 to about 0.97.

4. The toner composition according to claim 1, wherein the toner comprises a polymer, a colorant, and one or more components selected from the group consisting of surfactants, coagulants, waxes, surface additives, and optionally mixtures thereof.

5. The toner composition according to claim 1, wherein the toner is an emulsion aggregation toner.

6. The toner composition according to claim 1, wherein the toner has an average particle size of from about 5 microns to about 8 microns.

7. The toner composition according to claim 1, wherein the toner has an average particle size of from about 5 microns to about 6.5 microns.

8. A xerographic system comprising a charging component, an imaging component, a development component, a transfer component and a fixing component, wherein the development component comprises a toner composition having particles with a size of from about 2 microns to about 4 microns present in an amount of from about 12 percent to about 25 percent by weight of the toner composition.

9. The system according to claim 8, wherein the particles have a circularity of from about 0.93 to about 0.98.

10. The system according to claim 8, further comprising a cleaning blade component.

11. The system according to claim 10, wherein the minimum blade load to clean is from about 11 grams per centimeter to about 39 grams per centimeter.

12. The system according to claim 10, wherein the minimum blade load to clean is from about 12 grams per centimeter to about 30 grams per centimeter.

13. The system according to claim 8, wherein the development component comprises a toner composition comprising particles having a size of from about 2.25 microns to about 3.75 microns present in an amount of from about 14 percent to about 18 percent by weight of the total toner composition and a circularity of from about 0.94 to about 0.97.

14. A xerographic process comprising:
depositing a toner composition on a latent electrostatic image, the toner composition having particles with a size of from about 2 microns to about 4 microns present in an amount of from about 12 percent to about 25 percent by weight of the toner composition;
transferring the image to a support surface; and
affixing the image to the support surface.

15. The process according to claim 14, wherein the particles have a circularity of from about 0.93 to about 0.98.

16. The process according to claim 14, wherein the toner has a transfer efficiency of from about 75 percent to about 100 percent.

17. The process according to claim 14, wherein the affixed image has a solid area image density of from about 12 to about 30 L* units at development voltages of from about 100V to about 400V.

18. The process according to claim 14, wherein the affixed image has a solid area image density of from about 19 to about 22 L* units at development voltages of from about 150V to about 390V.

19. A developer composition comprising carrier particles and toner with particles having a size of from about 2 microns to about 4 microns present in an amount of from about 12 percent to about 25 percent by weight of the toner composition.

20. The developer composition according to claim 19, wherein the particles have a circularity of from about 0.93 to about 0.98.

21. The developer composition according to claim 19, wherein the toner comprises at least one polymer, at least one colorant, and one or more components selected from the group consisting of surfactants, coagulants, waxes, surface additives, and optionally mixtures thereof.

22. The developer composition according to claim 19, wherein the particles have a size of from about 2.25 microns to about 3.75 microns present in an amount of from about 14 percent to about 18 percent by weight of the total toner composition and a circularity of from about 0.94 to about 0.97.
